(19) United States
(12) Patent Application Publication
(10) Pub. No.: US 2022/0374689 A1
(43) Pub. Date: Nov. 24, 2022

(54) METHODS AND SYSTEMS FOR COMPUTING AN OUTPUT OF A NEURAL NETWORK LAYER

(71) Applicants: Xinlin LI, Montreal (CA); Mariana Oliveira PRAZERES, Parede (PT); Adam Morrison OBERMAN, Outremont (CA); Vahid PARTOVI NIA, Montreal (CA)

(72) Inventors: Xinlin LI, Montreal (CA); Mariana Oliveira PRAZERES, Parede (PT); Adam Morrison OBERMAN, Outremont (CA); Vahid PARTOVI NIA, Montreal (CA)

(21) Appl. No.: 17/317,833

(22) Filed: May 11, 2021

(51) Int. Cl. G06N 3/063; G06N 3/04; G06N 3/08

(52) U.S. Cl. CPC G06N 3/063; G06N 3/0454; G06N 3/08

(57) ABSTRACT

Systems and methods for computing a neural network layer of a neural network are described. A squared Euclidean distance is computed between the input vector and the weight vector of the neural network layer, replacing computation of the inner product. Methods for quantization of the squared Euclidean computation are also described. Methods for training the neural network using homotopy training are also described.

### FIELD

The present disclosure is related to methods and devices for computing an output of a neural network layer, in particular methods and devices using higher efficiency computations for computing the output of a neural network layer.

### BACKGROUND

A neural network is computational system comprising computational units (sometimes referred to as neurons) that are arranged in layers (or computational blocks). A neural network includes a first neural network layer (i.e. an input layer), at least one intermediate neural network layer (i.e. intermediate layer(s)) and a final neural network layer (i.e. an output layer). Each neural network layer receives input data (e.g., an input vector) and performs computations, including applying some weights (e.g., a weight vector) to the input data to generate output data (e.g., an output vector). If a neural network has multiple intermediate layers, the output generated by one intermediate layer (e.g. intermediate data) may be used as the input data to a subsequent intermediate layer. The output of a multi-layer neural network is the output generated by the final layer. A convolutional neural network (CNN) is a type of neural network in which there is at least one neural network layer that performs convolution (e.g. applies a convolutional kernel composed of weights to the input data to compute a similarity between the input data and the convolutional kernel).

A CNN is frequently used for performing computer vision tasks (e.g., object detection), natural language processing tasks (e.g., machine translation) and other such tasks. To improve the performance of a CNN that may be trained using a large dataset that includes complex data samples, such as improving prediction accuracy of a CNN which performs an image classification task, architectures for CNNs have been increasing in the number of layers and in complexity. More complex CNN architectures require more computational resources (e.g., energy use, memory resources, processing cycles, and processing power) to perform the computations of the layers of a CNN and store the intermediate data generated by the intermediate layers of the CNN, during both training of the CNN and when the trained CNN is used for inference.

Accordingly, there is a need for techniques that can perform the computations of a neural network layer with greater efficiency.

### SUMMARY

In various examples, the present disclosure describes a technique, referred to herein as a squared Euclidean operator, which may replace the inner product operator that is conventionally used to compute the output of a neural network layer, such as a convolutional neural network layer or a fully connected neural network layer of a neural network. The present disclosure also describes example neural networks including at least one neural network layer whose output is computed using the squared Euclidean operator instead of the inner product operator.

A hardware device (e.g., dedicated neural network accelerator, or other semiconductor device) is disclosed that is designed to compute the output of a neural network layer using squared Euclidean operators. In some examples, the hardware device may be part of a processing unit (e.g., a processing unit that includes a host processor of a computing system) or may be a standalone semiconductor device. Compared to a conventional neural network or AI accelerator that is designed to compute the output of a neural network layer using inner product operators, the disclosed hardware device, by using squared Euclidean operators, may compute the output of a neural network layer with higher efficiency (e.g., require lower energy usage, fewer memory resources and/or lower computing power) than by using the inner product operators. Further, the number of logic gates that are required to implement the squared Euclidean operator in circuitry may be fewer than the number of logic gates that are required to implement a conventional inner product operator in circuitry, given the same number of input bits. Thus, the disclosed technique may allow for a reduction in hardware footprint (and hence a possible reduction in the size and/or cost of the processing unit).

In some example aspects, the present disclosure describes a computing system for computing the output of a neural network layer of a neural network. The computing system includes: a memory storing a weight vector for the neural network layer; and a processing unit coupled to the memory. The processing unit includes: circuitry configured to receive an input vector to the neural network layer and the weight vector for the neural network layer; circuitry configured to compute a squared Euclidean distance between the input vector and the weight vector by: for each element in the input vector and a corresponding element in the weight vector, computing a first difference and computing a square of the first difference; and computing a sum of the squares to obtain the squared Euclidean distance. The processing unit also includes: circuitry configured to output the squared Euclidean distance as an output element of an output vector of the neural network layer.

In the preceding example aspect of the computing system, in the processing unit, the circuitry configured to compute the squared Euclidean distance may include: logic gates for implementing a subtraction operator to compute the first difference; logic gates for implementing a square operator to compute the square of the first difference; and logic gates for implementing a summation operator to compute the sum of the squares.

In any of the preceding example aspects of the computing system, the neural network layer may be a convolutional neural network layer, the weight vector may be a convolutional kernel, and the memory may store instructions to cause the processing unit to compute the output vector of the convolutional neural network layer using the squared Euclidean distance between the input vector and the convolutional kernel.

In any of the preceding example aspects of the computing system, the neural network layer may be a fully connected neural network layer, the weight vector may represent multi-dimensional weights and the memory may store instructions to cause the processing unit to compute the output vector of the fully connected neural network layer using the squared Euclidean distance between each element in the input vector and each multi-dimensional weight represented by the corresponding element in the weight vector.

In any of the preceding example aspects of the computing system, the processing unit may be a dedicated neural network accelerator chip.

In any of the preceding example aspects of the computing system, the input vector and the weight vector may be integer vectors. The circuitry configured to receive the input vector and the weight vector may be further configured to receive a scaling value. The circuitry configured to compute the squared Euclidean distance may be further configured to compute the squared Euclidean distance by: for each element in the input vector and a corresponding element in the weight vector, computing the first difference, rounding the first difference, and computing a square of the rounded difference; and computing the sum of the squares and rounding the sum to obtain the squared Euclidean distance. The processing unit may further include: circuitry configured to compute a square of the scaling value. The circuitry configured to output the squared Euclidean distance may be further configured to output the square of the scaling value as an output scaling value of the output vector.

In any of the preceding example aspects of the computing system, the circuitry configured to receive the input vector, the weight vector and the scaling value may be further configured to receive a zero value difference. The circuitry configured to compute the squared Euclidean distance may be further configured to compute the squared Euclidean distance by: for each element in the input vector and a corresponding element in the weight vector, computing the first difference, computing a second difference between the first difference and the zero value difference, rounding the second difference, and computing the square of the rounded difference; and computing the sum of the squares and rounding the sum to obtain the squared Euclidean distance.

In some example aspects, the present disclosure describes a method for computing an output of a neural network layer of a neural network. The method includes: receiving an input vector to the neural network layer and a weight vector for the neural network layer; computing a squared Euclidean distance between the input vector and the weight vector by: for each element in the input vector and a corresponding element in the weight vector, computing a first difference and computing a square of the first difference; and computing a sum of the squares to obtain the squared Euclidean distance. The method also includes outputting the squared Euclidean distance as an output element of an output vector of the neural network layer.

In some example aspects, the present disclosure describes a method including: obtaining a set of pre-trained weights of a first neural network, the first neural network including a first neural network layer computed using an inner product operator, the inner product operator being defined based on inner product similarity; initializing a set of weights of a second neural network using values from the set of pre-trained weights, the second neural network having a network architecture equivalent to the first neural network, the second neural network replacing the first neural network layer with a second neural network layer computed using a homotopy training operator, the homotopy training operator being a continuous function that transforms the inner product operator to a squared Euclidean operator, the squared Euclidean operator being defined based on squared Euclidean similarity; initializing the homotopy training operator to be equivalent to the inner product operator; updating the set of weights of the second neural network over a plurality of training iterations, the homotopy training operator being adjusted towards the squared Euclidean operator over the plurality of training iterations; and after the homotopy training operator has transformed to the squared Euclidean operator and a convergence condition is satisfied, storing the updated set of weights as a set of trained weights of the second neural network.

In the preceding example aspect of the method, the homotopy training operator may be a parametric function, and the homotopy training operator may be adjusted towards the squared Euclidean operator by adjusting a continuous homotopy training parameter.

In any of the preceding example aspects of the method, initializing the homotopy training operator may include initializing the homotopy training parameter to a value of zero, and the homotopy training operator may be adjusted towards the squared Euclidean operator by adjusting the homotopy training parameter towards a value of one.

In any of the preceding example aspects of the method, the homotopy training operator may be defined as:

homotopy trainng operator=inner product operator+λ×residual operator

where λ is the homotopy training parameter, and the residual operator is defined as the difference between the squared Euclidean operator and the inner product operator.

In some example aspects, the present disclosure describes a method for computing an output of a neural network layer of a neural network. The method includes: receiving an input vector to the neural network layer and a weight vector for the neural network layer; computing a squared Euclidean distance between the input vector and the weight vector by: computing a first inner product between the input vector and the weight vector; computing a second inner product between the input vector and the input vector itself and applying a scaling factor; computing a third inner product between the weight vector and the weight vector itself and applying the scaling factor; and computing a sum of the first inner product, the scaled second inner product and the scaled third inner product to obtain the squared Euclidean distance. The method also includes outputting the squared Euclidean distance as an output element of an output vector of the neural network layer.

In the preceding example aspect of the method, the neural network layer may be a convolutional neural network layer, the weight vector may be a convolutional kernel, and the method may include computing the output vector of the convolutional neural network layer using the squared Euclidean distance between the input vector and the convolutional kernel, the squared Euclidean distance being computed by computing the first inner product, the second inner product, the third inner product and the sum.

In any of the preceding example aspects of the method, the neural network layer may be a fully connected neural network layer, the weight vector may represent multi-dimensional weights and the method may include computing the output vector of the fully connected neural network layer using the squared Euclidean distance between each element in the input vector and each multi-dimensional weight represented by the corresponding element in the weight vector, the squared Euclidean distance being computed by computing the first inner product, the second inner product, the third inner product and the sum.

In any of the preceding example aspects of the method, the method may include: converting instructions to compute the squared Euclidean distance by computing a squared Euclidean operator into instructions to compute the squared Euclidean distance by computing the first inner product, the second inner product, the third inner product and the sum.

### BRIEF DESCRIPTION OF THE DRAWINGS

Reference will now be made, by way of example, to the accompanying drawings which show example embodiments of the present application, and in which:

FIG. 1 is a computation graph illustrating example computations for computing a conventional inner product operator;

FIG. 2 is a computation graph illustrating example computations for computing a squared Euclidean operator, in accordance with examples of the present disclosure;

FIG. 3 is a block diagram illustrating an example computing system, including a processing unit that may be used to implement examples of the present disclosure;

FIG. 4 is a computation graph illustrating example computations for computing a decomposition of the squared Euclidean operator, in accordance with examples of the present disclosure;

FIG. 5 is a block diagram illustrating an example homotopy training operator that may be used for homotopy training, in accordance with examples of the present disclosure;

FIG. 6 is a flowchart illustrating an example method for homotopy training, in accordance with examples of the present disclosure;

FIG. 7 is a computation graph illustrating example computations for computing a conventional quantized inner product operator using a conventional quantization scheme;

FIG. 8 is a computation graph illustrating example computations for computing a quantized squared Euclidean operator using a first quantization scheme, in accordance with examples of the present disclosure;

FIG. 9 is a computation graph illustrating example computations for computing a quantized squared Euclidean operator using a second quantization scheme, in accordance with examples of the present disclosure; and

FIG. 10 is a block diagram illustrating an example of how a squared Euclidean-based convolutional neural network layer may be computed using a sum of conventional inner product-based convolutional neural network layers.

Similar reference numerals may have been used in different figures to denote similar components.

### DESCRIPTION OF EXAMPLE EMBODIMENTS

The present disclosure describes a technique, referred to as a squared Euclidean operator, which may be used to replace the inner product operator that is conventionally used to compute the output of a neural network layer. For example, the squared Euclidean operator may be used to compute the output of a convolutional neural network layer or the output of a fully connected neural network layer, instead of using the inner product operator. To assist in understanding the present disclosure, the conventional inner product operator is first discussed in the context of computing the output of a convolutional neural network layer.

A neural network having a convolutional neural network layer (also referred to simply as a convolutional layer) may be referred to as a convolutional neural network (CNN). It should be noted that a single convolutional neural network layer may be considered a CNN (i.e., it is not necessary for there to be multiple neural network layers in the CNN). Conceptually, the convolutional neural network layer generates an output that is based on the similarity between the input data (e.g., represented by a input vector, denoted as X) and a convolutional kernel composed of a set of weights (e.g., represented by a weight vector, denoted as W). One technique for computing the output of the convolutional neural network layer is to compute the inner product similarity between the vectors X and W, using the inner product operator.

The inner product operator computes the inner product between the vectors X and W, where X and W each have a length of n, to obtain the output (e.g. represented as an output vector, denoted as Y). This computation using the inner product operator may be expressed as follows:

$$Y = {\sum }_{i = 0}^{n} {X}_{i} ⨯ {W}_{i}$$

where Y is the inner product of vectors X and W; and where Xᵢ and Wᵢ are the i-th element of the vectors X and W, respectively.

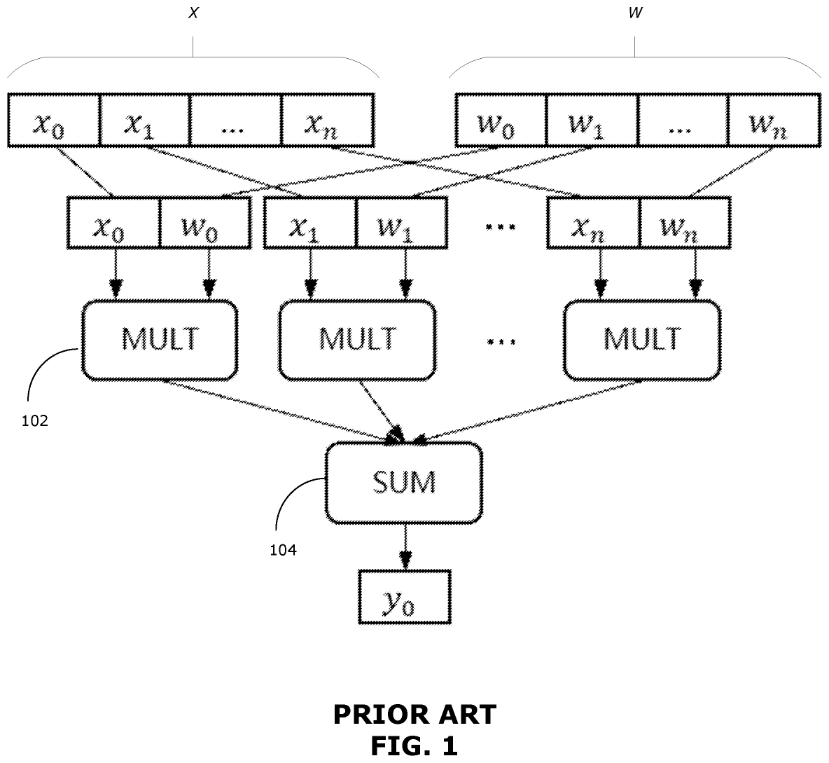

FIG. 1 is a computation graph illustrating the computations required to compute a single element y₀ of the output vector Y, using the inner product operator. The input vector X contains the elements x₀, x₁, . . . , xₙ, and the weight vector W contains the elements w₀, w₁, . . . , wₙ. Element-wise multiplication is performed by taking corresponding elements from the vectors X and W as inputs to a multiplication operator 102. The number of multiplication operators 102 required is equal to the length, n, of the vectors X and W. The outputs of the multiplication operators 102 are provided as input to a summation operator 104. The output of the summation operator 104 is the element y₀ of the output vector Y. It should be understood that each of the operators 102, 104 is implemented in hardware using circuitry that includes a set of logic gates that are in turn implemented using transistors.

The number of multiplication operators required to compute the inner product operator increases with the size of the input data (i.e. the number of elements in the input vector X). In the case where the inner product operator is used to compute the output of a convolutional neural network layer, the number of multiplication operators required increases with the size of the input data, the size of the convolutional kernel (i.e. the number of elements in the weight vector W), and the number of output channels of the convolutional neural network layer. For example, for a 2D convolutional neural network layer (e.g., commonly used for processing 2D images), the output of the convolutional neural network layer may be expressed as follows:

$$Y = Conv 2 D ( X , W ) {Y}_{h , w , {c}_{out}} = {\sum }_{{c}_{i n}}^{{N}_{i n}} {\sum }_{i = 0}^{k} {\sum }_{j = 0}^{k} {X}_{h + i , w + j , {c}_{i n}} ⨯ {W}_{i , j , {c}_{in} , {c}_{out}}$$

where cᵢₙ and cₒᵤₜ are the input and output channels, respectively; where X is a 2D patch of the input image, and where W is a 2D convolutional kernel. The input and output channels may each include a channel for a height of the input image, a channel for a width of the input image, and a channel for each feature of the input image. For a large input image, the inner product must be computed between the 2D convolutional kernel and many 2D patches of the input image (which may be referred to as “2D image patches”). It can be appreciated that, when the computations of a convolutional neural network layer is performed using the inner product operator, a large number of multiplication operators are required to compute the output Y, particularly when the input image is large.

The computations required to compute the output of a neural network layer (during training of the neural network and/or during use of the neural network for inference) are often performed by a dedicated neural network accelerator. Using the multiplication operator to compute the output of a convolutional layer of the neural network using the inner product operator results in the neural network being costly to compute, in terms of in computer hardware. By “costly” in computer hardware, it is meant that the multiplication operator requires circuitry that includes a large number of logic gates (and hence a large number of transistors) to implement in a processing unit. The cost of the multiplication operator is also high in terms of financial cost (e.g., high cost of manufacture a hardware device that implements the multiplication operator), energy cost (e.g., high energy consumption) and size cost (e.g., requires large hardware footprint on a hardware device, such as an ASIC or FPGA). Thus, using the conventional inner product operator to perform the computations of a neural network layer requires circuitry that takes up a considerable amount of the area in a dedicated neural network accelerator and results in the dedicated neural network accelerator consuming a significant amount of power when performing the computations of a neural network layer.

In various examples, the present disclosure describes methods and systems for computing the output vector Y of a neural network layer (e.g., a convolutional neural network layer, a fully connected neural network layer, or other neural network layer that conventionally is computed using the inner product operator) using squared Euclidean distance instead of inner product as a measurement of similarity. For clarity, a neural network layer whose computations for computing the output of the layer are performed using the inner product operator may be referred to as a conventional neural network layer, or an inner product-based neural network layer; whereas a neural network layer whose computations for computing the output of the layer are performed using the squared Euclidean operator may be referred to as a squared Euclidean-based neural network layer. The squared Euclidean-based neural network layer may be a fully connected neural network layer (and may be referred to specifically as a squared Euclidean-based fully connected neural network layer), or a convolutional neural network layer (and may be referred to specifically as a squared Euclidean-based convolutional neural network layer), for example.

Using the squared Euclidean operator instead of the inner product operator to compute the output of a neural network layer enables the computation of the output of the squared Euclidean-based neural network layer to be performed without requiring the use of the multiplication operator. Therefore, examples of the present disclosure may help to address the problem of high energy cost and high size cost in conventional computations of the outputs of neural network layers. More generally, the squared Euclidean-based neural network layer may be used in place of a conventional inner product-based neural network layer (e.g., a conventional convolutional layer or a conventional fully connected layer) in any neural network architecture. Unless specifically indicated otherwise, it should be understood that the examples described herein are generally applicable to computation of the output of any neural network layer in which the inner product operator may be replaced by the disclosed squared Euclidean operator.

The squared Euclidean operator may be expressed as follows:

$$Y = - \frac{1}{2} {\sum }_{i = 0}^{n} {( {X}_{i} - {W}_{i} )}^{2}$$

where Xᵢ and wᵢ are the i-th element of the input vector X and the weight vector W, respectively; where Y is the output vector; and where −½ is a constant scaling factor. The scaling factor is optional, and may be included to facilitate homotopy training in practical applications, as discussed further below.

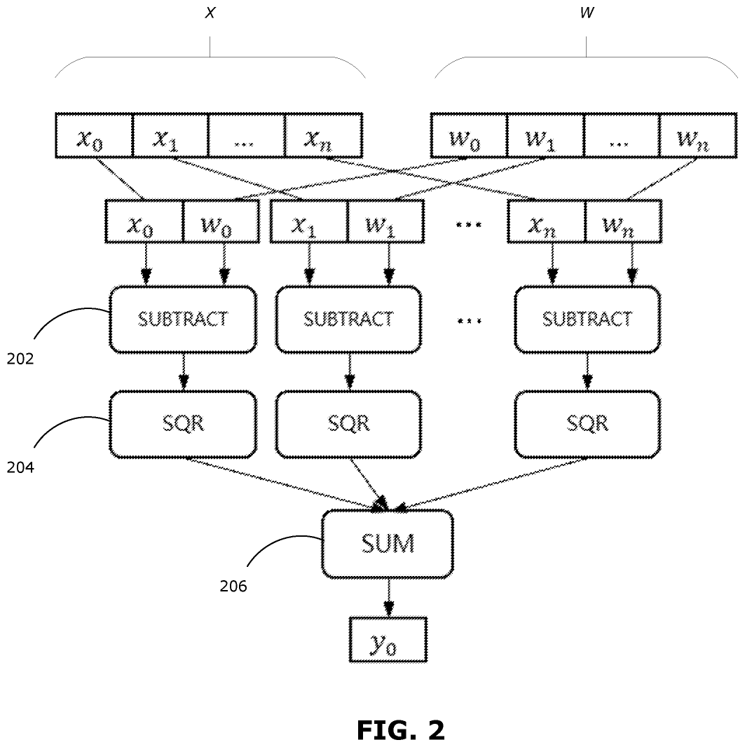

FIG. 2 is a computation graph illustrating the computations used to compute a single element y₀ of the output vector Y of a neural network layer using the squared Euclidean operator. The input vector X contains the elements x₀, x₁, . . . , xₙ, and the weight vector W contains the elements w₀, w₁, . . . , wₙ. Instead of using multiplication operators, as in computation of the element y₀ using the conventional inner product operator (e.g., as illustrated in FIG. 1), element-wise subtraction is performed by taking corresponding elements from the vectors X and W as inputs to a subtraction operator 202. The output of each subtraction operator 202 is provided as input to a respective square operator 204. The outputs of the square operators 204 are provided as input to a summation operator 206, and the output of the summation operator 206 is the single element y₀. It should be understood that each of the operators 202, 204, 206 is implemented in hardware as circuitry that includes a set of logic gates that are in turn implemented in using transistors.

As would be appreciated by one skilled in the art, a single subtraction operator 202 and a single square operator 204 together can be implemented using fewer logic gates (and hence fewer transistors) than a single multiplication operator (e.g., the multiplication operator 102 illustrated in FIG. 1). The result is that the computations required to compute the output of the squared Euclidean-based neural network layer are more efficient (e.g., having lower energy cost and occupying smaller hardware footprint (i.e. less area of the hardware device) as compared to computations required to compute the output of the conventional inner product-based neural network layer. Accordingly, a dedicated neural network accelerator that is designed to compute squared Euclidean operators instead of inner product operators can perform computations to compute the output of a neural network more efficiently.

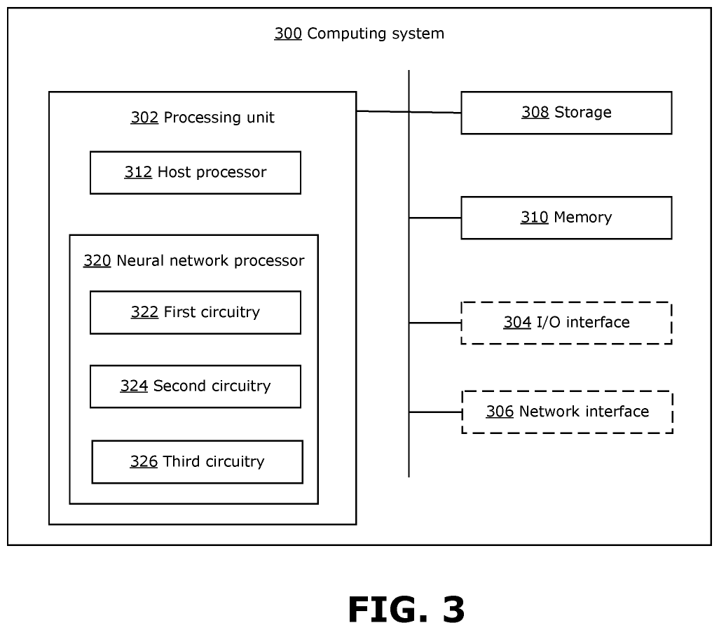

FIG. 3 block diagram illustrating an example computing system 300, including a processing unit 302 that may be used to compute the output of a neural network. In particular, the computing system 300 may include a processing unit 302 that is designed to compute squared Euclidean operator to compute a neural network, instead of computing inner product operators.

The processing unit 302 may be implemented in other computing systems having different configurations and/or having different components than those shown in FIG. 3. The computing system 300 may be used to execute instructions for training a neural network and/or to execute instructions of a trained neural network to generate inference output. In some examples, the computing system 300 may be used for executing a trained neural network, and training of the neural network may be performed by a different computing system; or the computing system 300 may be used for training the neural network, and execution of the trained neural network may be performed by a different computing system; or the computing system 300 may be used for both training the neural network and for executing the trained neural network.

Although FIG. 3 shows a single instance of each component, there may be multiple instances of each component in the computing system 300. Further, although the computing system 300 is illustrated as a single block, the computing system 300 may be a single physical machine or device (e.g., implemented as a single computing device, such as a single workstation, single consumer device, single server, etc.), or may comprise a plurality of physical machines or devices (e.g., implemented as a server cluster). For example, the computing system 300 may represent a group of servers or cloud computing platform providing a virtualized pool of computing resources (e.g., a virtual machine, a virtual server).

The processing unit 302 may include any suitable hardware device, such as a processor, a microprocessor, an application-specific integrated circuit (ASIC), a field-programmable gate array (FPGA), a dedicated logic circuitry, or combinations thereof. The processing unit 302 may be a central processing unit (CPU), a graphics processing unit (GPU), a tensor processing unit (TPU), or a neural processing unit (NPU), for example. In the example shown, the processing unit 302 includes a host processor 312 and a hardware device, such as a neural network processor 320 (e.g., a dedicated neural network accelerator or AI accelerator), that is designed for computation of the squared Euclidean operator.

The neural network processor 320 includes circuitry designed to perform computations for computing the squared Euclidean operator. The circuitry of the neural network processor 320 includes first circuitry 322 to receive an input vector and a weight vector, second circuitry 324 to compute the squared Euclidean distance between the input vector and the weight vector, and third circuitry 326 to output the squared Euclidean distance as an output element of the output vector. In particular, the neural network processor 320 has the second circuitry 324 that includes hardware (e.g., including transistors and electrical connectors) implementing the logic gates for the operators 202, 204, 206 illustrated in FIG. 2, to enable computation of the squared Euclidean operator. It should be noted that the circuitry 322, 324, 326 of the neural network processor 320 may implement multiple instances of the computations illustrated in FIG. 2, for example to enable parallel computation of the squared Euclidean operator.

The computing system 300 may also include an optional input/output (I/O) interface 304, which may enable interfacing with other devices. The computing system 300 may include an optional network interface 306 for wired or wireless communication with a network (e.g., an intranet, the Internet, a P2P network, a WAN and/or a LAN) and/or another computing device. In some examples, the computing system 300 may communicate with a cloud computing platform via the network interface 306, for example to access cloud-based resources (e.g., a cloud-based service for training a neural network).

The computing system 300 may also include a storage unit 308, which may include a mass storage unit such as a solid state drive, a hard disk drive, a magnetic disk drive and/or an optical disk drive. The computing system 300 may include a memory 310, which may include a volatile or non-volatile memory (e.g., a flash memory, a random access memory (RAM), and/or a read-only memory (ROM)). The non-transitory memory 310 may store instructions for execution by the processing unit 302, including instructions for computing the output of a neural network by the neural network processor 320. The memory 310 may include other software instructions, such as for implementing an operating system and other applications/functions. In some examples, the memory 310 may include software instructions and data (e.g., weight values) to enable the processing unit 302 to compute the output of a trained neural network.

Although the memory 310 is illustrated as a single block, it should be understood that the memory 310 may comprise one or more memory units. For example, the memory 310 may include a cache for temporary storage of instructions. The cache may enable the processing unit 302 to more quickly access instructions during execution, thus speeding up execution of the instructions. In some examples, the processing unit 302 may also include one or more internal memory units, such as an input buffer that stores input data (e.g., input data to be forward propagated through one or more neural network layers), a weight buffer that stores weight data (e.g., one or more sets of weights for respective one or more neural network layers), and an output buffer that stores output data (e.g., output data computed from one or more neural network layers). Internal memory of the processing unit 302 may be used for temporary storage of data during execution of a neural network (e.g., during training and/or inference), and may be cleared after execution is complete.

In some examples, one or more data sets and/or modules may be provided by an external memory (e.g., an external drive in wired or wireless communication with the computing system 300) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

The computing system 300 may be used to compute the output of a neural network (e.g., during training and/or during inference). In particular, the computing system 300 may be used to compute the output of a squared Euclidean-based neural network (i.e., a neural network that includes one or more squared Euclidean-based neural network layers). For example, instructions encoding the architecture of the neural network may be stored in the memory 310 (or the storage 308), and weights of the neural network layers may be stored as data in the memory 310 (or the storage 308). To compute a squared Euclidean-based neural network layer of the neural network, a weight vector for the squared Euclidean-based neural network layer (e.g., retrieved from a cache or weight buffer) and an input vector to the squared Euclidean-based neural network layer (e.g., retrieved from an cache or input buffer) are received by the processing unit 302. The input vector may be a subset of the input data to the squared Euclidean-based neural network layer. For example, the input data to the squared Euclidean-based neural network layer may be an input image, or a multi-dimensional matrix of activation values (e.g., from a preceding neural network layer). In the case where the input data is an input image (e.g., a 2D image), the input vector may represent a patch of the image inputted to the squared Euclidean-based neural network layer. The processing unit 302 computes an output element, by computing the squared Euclidean distance between the input vector and the weight vector. The output element may be stored in a cache or output buffer. An output vector may be computed for the squared Euclidean-based neural network layer by computing each output element as described above (i.e., computing the squared Euclidean distance between a respective input vector and the weight vector), and accumulating the output elements (e.g., in a cache or output buffer) until the entire output vector has been computed. The computed output vector may be used as input to compute a following layer of the neural network, or may be outputted as the output of the neural network (e.g., if the squared Euclidean-based neural network layer is the final layer of the neural network).

As mentioned above, the computing system 300 may be used to execute a trained neural network using a hardware device of the processing unit 302 (e.g., using the neural network processor 320), however training of the neural network may be performed by a different computing system. For example, training of the neural network may be performed by a workstation, a server, server cluster, virtual computing system, or cloud-based computing platform, among other possibilities, external to the computing system 300. The external system that trains the neural network may use a processing unit that may or may not be designed to compute squared Euclidean operators. For example, training of the neural network may be performed using a conventional processing unit (e.g., TPU, GPU, CPU, NPU, or other dedicated neural network accelerator chip) that is designed to compute conventional inner product operators. The training may be performed by an external system that has access to greater computing resources (e.g., memory resources, computing power, etc.) and for which the inefficiencies of using the inner product operator may be less of a concern. The computing system 300 that executes the trained neural network may have more limited computing resources (e.g., fewer memory resources, less computing power, limited battery power, etc.) and may benefit more from using the squared Euclidean operator instead of the inner product operator to execute the trained neural network.

A conventional processing unit (or AI accelerator) that is designed to compute inner product operators may be less efficient at computing the disclosed squared Euclidean operator. It would be useful to enable computation of the output of a squared Euclidean-based neural network layer by a computing system having a conventional processing unit. The present disclosure describes a decomposition of the squared Euclidean operator, to enable a computing system having a conventional processing unit and AI accelerator to compute the output of a squared Euclidean-based neural network layer.

The squared Euclidean operator may be decomposed into a sum of inner product operators, which may enable a conventional processing unit to efficiently compute an equivalent of the squared Euclidean operator. For example, a compiler or other software may convert a squared Euclidean operator into a sum of inner product operators, to enable more efficient computation by a conventional processing unit. The following equation illustrates how the squared Euclidean operator may be decomposed into a sum of inner product operators:

$$Y = - \frac{1}{2} {\sum }_{i = 0}^{n} {( {X}_{i} - {W}_{i} )}^{2} = {\sum }_{i = 0}^{n} {X}_{i} ⨯ {W}_{i} - \frac{1}{2} {\sum }_{i = 0}^{n} {X}_{i} ⨯ {X}_{i} - \frac{1}{2} {\sum }_{i = 0}^{n} {W}_{i} ⨯ {W}_{i}$$

where Xᵢ and Wᵢ are the i-th element of the input vector X and the weight vector W, respectively; where Y is the output vector; and where is a constant scaling factor. As illustrated in the above equation, the squared Euclidean operator may be decomposed into a sum of three inner product operators, where the first inner product operator computes an inner product of the vectors X and W, the second inner product operator computes an inner product of the vector X with itself, and the third inner product operator computes an inner product of the vector W with itself. The constant scaling factor of

$$- \frac{1}{2}$$

is applied to the second and third inner product operators.

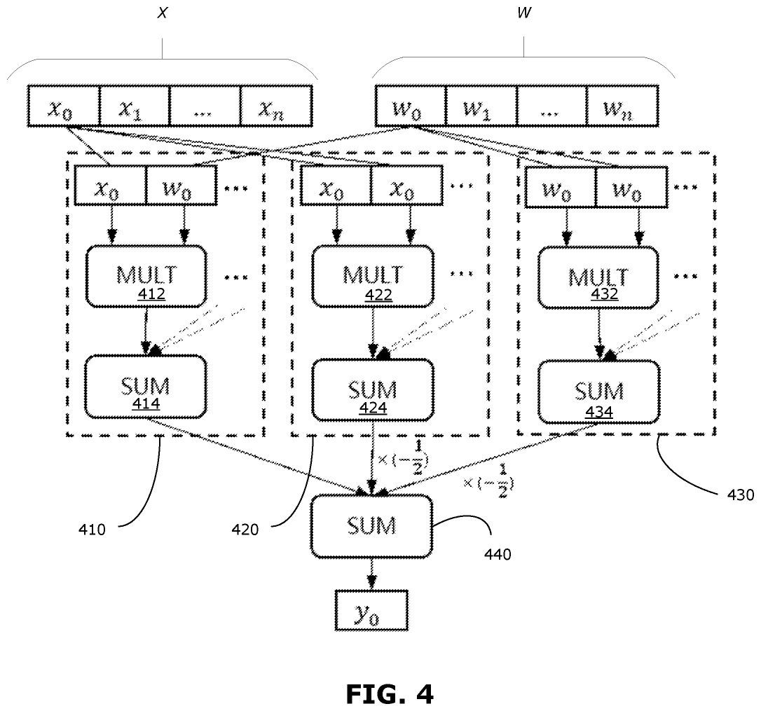

FIG. 4 is a computation graph illustrating the computations used to compute a single output element y₀, using a sum of inner product operators (i.e., using a decomposition of the squared Euclidean operator). The input vector X contains the elements x₀, x₁, . . . , xₙ, and the weight vector W contains the elements w₀, w₁, . . . , wₙ The computations involve a first set of computations 410 for computing the first inner product operator (i.e., the inner product of the vectors X and W), a second set of computations 420 for computing the second inner product operator (i.e., the inner product of the vector X with itself) and a third set of computations 430 for computing the third inner product operator (i.e., the inner product of the vector W with itself).

Each set of computations 410, 420, 430 involves performing element-wise multiplication using a respective set of multiplication operators 412, 422, 432. For simplicity, only one multiplication operator 412, 422, 432 is illustrated for each set of computations 410, 420, 430, however it should be understood that the number of multiplication operators 412, 422, 432 in each respective set of computations 410, 420, 430 is equal to the number of elements in each vector X and W. That is, for vectors X and W of length n (i.e., having n elements), there are n instances of the multiplication operators 412, 422, 432 in each respective set of computations 410, 420, 430. Each set of computations 410, 420, 430 also involves summing the outputs of the respective multiplication operators 412, 422, 432, using a respective summation operator 414, 424, 434. A constant scaling factor of

$$- \frac{1}{2}$$

is applied to the outputs of the second and third sets of computations 420, 430. Inputs to a final summation operator 440 is the output of the first set of computations 410 (i.e., the output of the first inner product operator), the scaled output of the second set of computations 420 (i.e., the scaled output of the second inner product operator) and the scaled output of the third set of computations 430 (i.e., scaled output of the third inner product operator). The output of the final summation operator 440 is the output element y₀. It should be understood that each of the operators 412, 414, 422, 424, 432, 434, 440 is implemented in hardware as circuitry that includes a set of logic gates that are in turn implemented using transistors.

In some examples, the present disclosure describes a method that may be performed by a conventional processing unit (i.e., a processing unit having circuitry designed for computing the inner product operator), to enable computation of a squared Euclidean-based neural network layer more efficiently. For example, a compiler or other set of computer instructions may convert instructions for computing the squared Euclidean-based neural network layer using the squared Euclidean operator into instructions for computing the squared Euclidean-based neural network layer using a sum of inner products as described above. A weight vector for the squared Euclidean-based neural network layer and an input vector to the squared Euclidean-based neural network layer are received by the processing unit. The input vector may be a subset of the input data (e.g., an input image represented by a multi-dimensional matrix, or a multi-dimensional matrix of activation values) to the squared Euclidean-based neural network layer. The processing unit computes each output element of the output vector by computing the squared Euclidean operator as a sum of inner product operators. A first inner product is computed between the input vector and the weight vector, a second inner product is computed between the input vector and itself, and a third inner product is computed between the weight vector and itself. The output is computed as a sum of the first inner product, the second inner product (with constant scaling factor of

$$- \frac{1}{2}$$

applied) and the third inner product (with constant scaling factor

$$- \frac{1}{2}$$

applied). Each output element may be computed and accumulated until all elements of the output vector have been computed. The computed output vector may be used as input to compute a following layer of the neural network, or may be outputted as the output of the neural network.

In some examples, the neural network including the squared Euclidean-based neural network layer may be trained by using a trained conventional neural network (which includes a conventional inner product-based neural network layer) as a starting point. The disclosed training method may be referred to as homotopy training. Two functions that can be continuously transformed from one to the other (and vice versa) are referred to as being homotopic. In the present disclosure, homotopy training refers to training that is performed to convert a first neural network (which includes a conventional inner product-based neural network layer) to a second neural network (which includes a squared Euclidean-based neural network layer instead of the inner product-based neural network layer). The first neural network and the second neural network have the same network architecture, with the only difference being that the first neural network is computed based on inner product similarity (i.e., one or more layers in the network architecture are inner product-based neural network layer(s)) and the second neural network is computed based on squared Euclidean similarity (i.e., the same one or more layers in the network architecture are squared Euclidean-based neural network layer(s) instead). Thus, homotopy training enables a first neural network that was trained using the inner product operator to be converted to a second neural network that uses the squared Euclidean operator instead.

It has been found, in simulations and studies, that using homotopy training to convert a first neural network (that was trained based on inner product similarity) to a second neural network (that is based on squared Euclidean similarity) results in a second neural network that achieves prediction accuracy that is at least as high as the first neural network.

In order to successfully convert the first neural network (that uses the inner product operator) to the second neural network (that uses the squared Euclidean operator) using homotopy training, it is necessary to have a continuous transformation from the inner product operator to the squared Euclidean operator. The present disclosure describes a homotopy training operator (referred to herein as the HT operator). The homotopy training operator is defined as a continuous function that transforms from a source operator to a target operator, with the transformation being controlled by a homotopy training parameter (referred to herein as the HT parameter, denoted as A). For converting the first neural network to the second neural network, the source operator is the inner product operator and the target operator is the squared Euclidean operator. For simplicity, a neural network layer in which the HT operator is used during homotopy training is referred to herein as the HT layer. At the beginning of homotopy training, the HT operator is equivalent to the source operator (i.e., the inner product operator) and the HT layer is equivalent to an inner product-based neural network layer; at the end of homotopy training, the HT operator is equivalent to the target operator (i.e., the squared Euclidean operator) and the HT layer is equivalent to a squared Euclidean-based neural network layer. By replacing the inner product-based neural network layer(s) with equivalent HT layer(s), the first neural network can be converted to the second neural network using homotopy training.

The HT operator is defined as follows:

HTOperator(X,W,λ)=SourceOperator(X,W)+λ×ResidualOperator(X,W)

ResidualOperator(X,W)=TargetOperator(X,W)−SourceOperator(X,W)

where X is the input vector, W is the weight vector, and λ is a continuous HT parameter having a continuous value between [0,1]. When λ=0, the HT operator is equivalent to the source operator (i.e., the inner product operator) and when λ=1, the HT operator is equivalent to the target operator (i.e., the squared Euclidean operator). Thus, the HT operator is a continuous parametric function, which is continuously transformable between the source operator and the target operator and controlled by the HT parameter A.

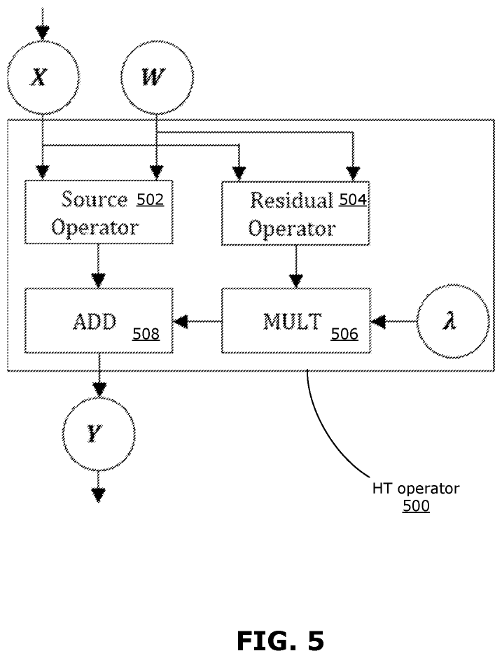

FIG. 5 is a block diagram illustrating example computations used to compute the HT operator. The HT operator 500 operates on the input vector X (which contains the elements x₀, x₁, . . . , xₙ) and the weight vector W (which contains the elements w₀, w₁, . . . , wₙ).

To compute the output vector Y, the vectors X and W are inputted to the source operator 502 and the residual operator 504. The output of the residual operator 504 is provided to a multiplication operator 506 to multiply with the HT parameter A (which is gradually adjusted from a value of 0 to a value of 1). The output of the source operator 502 and the multiplication operator 506 are provided to an element-wise addition operator 508. The output of the element-wise addition operator 508 is the output vector Y.

In particular, the source operator 502 is the inner product operator:

$${SourceOperator}_{Inner} ( X , W ) = {\sum }_{i = 0}^{n} {X}_{i} \times {W}_{i}$$

and the target operator is the squared Euclidean operator:

$${TargetOperator}_{Euclid} ( X , W ) = - \frac{1}{2} {\sum }_{i = 0}^{n} {( {X}_{i} - {W}_{i} )}^{2}$$

Accordingly, the residual operator 504 is defined as:

$${ResidualOperator}_{Inner \to Euclid} ( X , W ) = - \frac{1}{2} ( {\sum }_{i = 0}^{n} {X}_{i} \times {X}_{i} + {\sum }_{i = 0}^{n} {W}_{i} \times {W}_{i} )$$

It may be seen in the above equations that the

$$- \frac{1}{2}$$

a constant scaling factor in the squared Euclidean operator simplifies the computation of the residual operator 504, by simplifying subtraction of the inner product operator from the squared Euclidean operator. The residual operator 504 computes a smooth transition between the source operator 502 and the target operator controlled by the HT parameter λ.

It should be understood that each of the operators 502, 504, 506, 508 represent a set of logic gates that are in turn implemented in hardware using transistors. Further, the source operator 502 and the residual operator 504 may each be computed using more basic multiplication and summation operators.

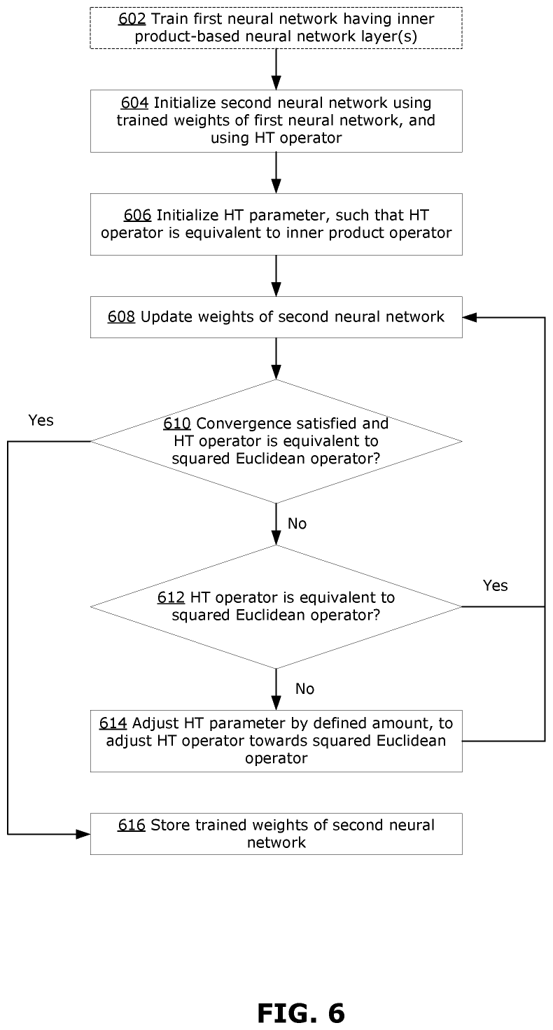

FIG. 6 is a flowchart illustrating an example method 600 for training a neural network having a squared Euclidean-based neural network layer, using a trained conventional neural network (i.e., having a conventional inner product-based neural network layer) as a starting point. The method 600 may be performed by any computing system that is capable of computing the HT operator, including any computing system that has a processing unit designed to compute inner product operators.

Optionally, at 602, the first neural network is trained (e.g., using any suitable conventional training method to optimize a defined loss function). The first neural network is a conventional neural network that includes one or more conventional inner product-based neural network layers (i.e., one or more neural network layers computed using inner product similarity). In some examples, the first neural network may have been previously trained and step 602 may be omitted.

At 604, the second neural network is initialized using the trained values of the weights of the first neural network. The second neural network has the same architecture as the first neural network and is designed to perform the same inference task. The difference between the first and second neural networks is that all inner product-based neural network layers in the first neural network is replaced with corresponding HT layers in the second neural network. That is, each inner product-based neural network layer in the first neural network is replaced with a respective HT layer having the same dimensions, same kernel size, and so forth. Each HT layer uses the HT operator to compute the output of the HT layer, instead of using the inner product operator.

The trained values of the weights of the first neural network may be retrieved from a storage or memory and used to initialize the second neural network. In particular, the trained values of the weights of the inner product-based neural network layer(s) of the first neural network are used to initialize the values of the weights of the respective HT layer(s) of the second neural network.

At 606, the HT parameter A is initialized such that the HT operator is equivalent to the inner product operator. In particular, the HT parameter A is set to a value of 0.

At 608, the values of the weights of the second neural network are updated. This may involve performing one training iteration, including forward propagating a batch of data samples from the training dataset (i.e., inputting each data sample in the batch into the second neural network to compute a respective output, until the entire batch of data samples have been processed), computing a loss function (e.g., based on an error or loss between the computed output and a ground-truth label associated with the training data samples), and using gradient descent (or other suitable backpropagation algorithm) to update the value of the weights. It should be noted that the loss function that is used for training the second neural network should be the same as the loss function that was used for training the first neural network (since the first and second neural networks have the same architecture and are designed to perform the same inference task). The training dataset that is used to train the second neural network may or may not be the same as that used to train the first neural network. For example, if the training dataset that was used to train the first neural network is not accessible or is out of date, the second neural network may be trained using a different training dataset.

In some examples, the step 608 may be repeated for a number of iterations, to complete one epoch of training (one epoch being one pass through the entire training dataset), before proceeding to step 610.

At 610, it is determined whether a convergence condition is satisfied and the HT operator is equivalent to the squared Euclidean operator. The convergence condition may be defined to be convergence of the loss function, a maximum number of iterations (or epochs) being reached, or any other suitable convergence condition (including combinations thereof). Determining whether the HT operator is equivalent to the squared Euclidean operator may involve simply determining whether the HT parameter A has a value of 1.

If the convergence condition is not satisfied and/or the HT operator is not equivalent to the squared Euclidean operator (e.g., the value of the HT parameter λ is less than 1), the method 600 proceeds to step 612.

At 612, it is determined whether the HT operator is equivalent to the squared Euclidean operator (e.g., the value of the HT parameter λ is equal to 1). If so, the method 600 returns to step 608 to perform further training to update the value of the weights of the second neural network. If not, the method 600 proceeds to step 614.

At 614, the HT parameter λ is adjusted by a defined amount, so that the HT operator is slowly adjusted towards the squared Euclidean operator. As previously discussed, the HT operator may be defined such that the HT operator is equivalent to the inner product operator when the HT parameter λ has a value of 0, and is equivalent to the squared Euclidean operator with the HT parameter λ has a value of 1. By slowly increasing the HT parameter λ from 0 to 1, the HT operator is gradually converted from the inner product operator to the squared Euclidean operator, which may help to ensure that the value of the weights of the second neural network smoothly converge to their final trained values.

The defined amount by which the HT parameter λ is adjusted may be defined to ensure that the HT parameter λ is linearly increased from a value of 0 to a value of 1. For example, the defined amount may be defined such that the HT parameter λ is linearly increased from a value of 0 to a value of 1 over a defined number of iterations or a defined number of epochs. For example, if the number of epochs is selected to be 50, then the defined amount may be 0.02, such that the HT parameter λ is linearly from a value of 0 to a value of 1 over 50 epochs. Whether the defined amount is defined based on the number of iterations or based on the number of epochs may depend on whether step 608 proceeds to step 610 after one iteration, or whether step 608 proceeds to step 610 after one epoch. The defined amount may be defined in other ways, for example the HT parameter λ may be non-linearly increased from a value of 0 to a value of 1.

After adjusting the HT parameter λ by the defined amount, the method 600 returns to step 608 to perform further training to update the weights of the second neural network.

Returning to step 610, if the convergence condition is satisfied and the HT operator is equivalent to the squared Euclidean operator, then the second neural network has be satisfactorily trained to use squared Euclidean-based neural network layer(s) in place of inner product-based neural network layer(s). The method 600 proceeds to step 616 to store the trained values of the weights of the second neural network, and the method 600 may then end.

If the training is performed by a training computing system and a different execution computing system will execute the trained second neural network, the trained values of the weights may be communicated from the training computing system to the execution computing system. The trained second neural network may be executed by the computing system 300 described previously, using the processing unit 302 that is designed to compute the squared Euclidean operator.

It should be noted that the HT operator and the homotopy training disclosed herein are not limited to converting from the inner product operator to the squared Euclidean operator. In general, the HT operator and homotopy training may be used to convert from any source operator to any target operator in the HT layer.

Quantization is another technique that has been developed to reduce computational cost and/or memory usage for computing the output of a neural network. During training, the computations of a neural network may be performed at high precision. For example, the values of the weights of the neural network may be stored in a tensor, where each element of the tensor is in 32 bit floating-point format. The computations of the neural network may be performed using this high precision format. However, it may not be practical for the learned values of the weights of the neural network to be stored at such a high precision on a computing system (e.g., consumer device, or edge computing device) having a limited amount of memory. For example, training of a neural network may be performed by a computing system (e.g., physical or virtual machines provided by a cloud-computing platform) having large amount of processing power and a large amount of memory, but execution of the trained neural network may be performed by a different computing system (e.g., consumer device, or edge computing device) that has limited processing power and/or memory resources. Quantization is a technique which reduces the memory and processing requirements for performing the computations of a neural network and storing the tensors of a neural network by reducing the number of bits required to store each value of a weight of the neural network, and the number of bits required to store the output of each neural network layer. Instead of using high-precision floating-point tensors to store the values of the weights, quantization uses low-precision integer tensors, with a shared zero point and scaling factor, to store the values of the weights.

In some examples, quantization may be used so that the values of the weights of a neural network can be stored using low-precision integer format during training (instead of using quantization to convert the learned values of the weights after the neural network has been trained). Using quantization during training of a neural network may be referred to as quantization aware training (QAT) whereas quantization after training of a neural network may be referred to as post-training quantization (PTQ). Regardless of whether QAT or PTQ is used, the result is that 8 bit operators may be used to perform the majority of computations of the trained neural network. The following discussion may be equally applicable to both QAT and PTQ.

8 bit quantization is a technique that has been commonly used to reduce the amount of memory required to store and perform the computations of a neural network. An example quantization scheme is defined as follows:

floating point value=(integer value−zero point value)×scale value

In a commonly used 8 bit quantization scheme, weight values are converted from 32 bit floating-point format to 8 bit integer format. The scale value, which is a floating point value stored in a single 32 bit floating-point format, and the zero point value, which is an integer value stored in 8 bit integer format, are shared by all the quantized weight values. It should be noted that different quantization schemes may be used (e.g., the 8 bit integer value may use signed 8 bit integer format or unsigned 8 bit integer format, and the zero point value may use 32 bit integer format or 32 bit floating point format). As example quantization scheme for computing a neural network layer may quantize the input values Xᵢ and weight values Wᵢ as follows:

Xᵢ=sₓ(x_{qi}−zₓ)

Wᵢ=s_{w}(W_{qi}−z_{w})

where X_{qi} is the quantized integer value of Xᵢ, Sₓ is the scaling value shared by all input values Xᵢ, zₓ is the zero point value shared by all input values Xᵢ, W_{qi} is the quantized integer value of Wᵢ, S_{w} is the scaling value shared by all input values Wᵢ, and z_{w} is the zero point value shared by all input values Wᵢ. To reduce the computational cost, the zero point values zₓ and z_{w} are usually both set to 0.

Using this quantization scheme (and setting zₓ=z_{w}=0), the conventional inner product operator may be quantized as follows:

$$Y = {\sum }_{i = 0}^{n} {X}_{i} \times {W}_{i} \\ = {\sum }_{i = 0}^{n} {S}_{x} ( {X}_{q i} - {z}_{x} ) \times {S}_{w} ( {W}_{q i} - {z}_{w} ) \\ = {S}_{x} {S}_{w} {\sum }_{i = 0}^{n} ( {X}_{q i} - {z}_{x} ) \times ( {W}_{q i} - {z}_{w} ) \\ = {S}_{x} {S}_{w} {\sum }_{i = 0}^{n} {X}_{q i} \times {W}_{q i}$$

Thus, the conversion from floating point inner product operator to quantized inner product operator may be expressed as follows:

InnerProduct_{float}(X,W)=SₓS_{w}InnerProductᵢₙₜ₈(X_{q},W_{q})

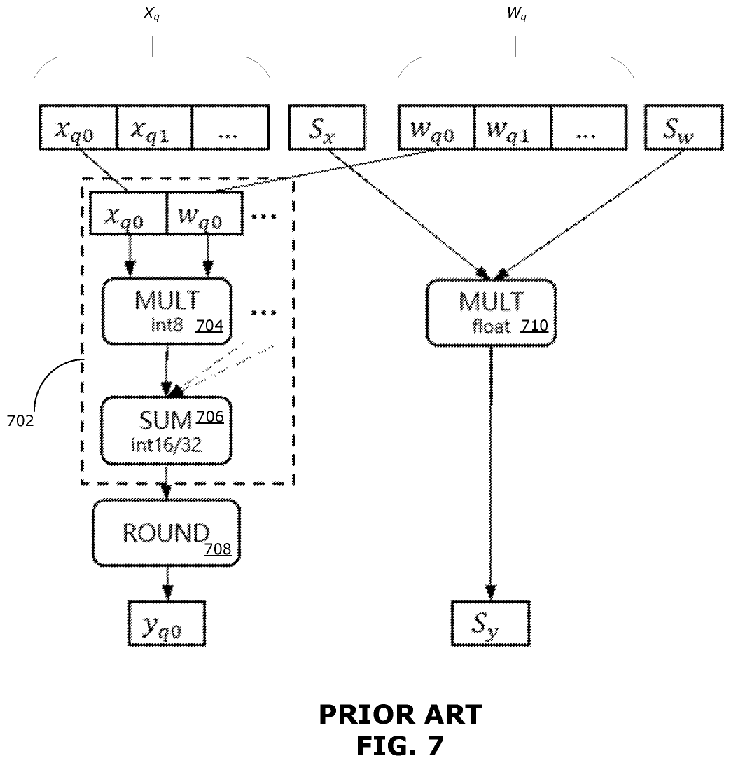

FIG. 7 is a computation graph illustrating the computations required to compute a quantized inner product operator. The quantized input vector X_{q} contains the integer elements x_{q0}, x_{q1}, . . . , X_{qn}, which share a zero point value zₓ that is set to 0 and share the scaling value Sₓ. The quantized weight vector W_{q} contains the elements w_{q0}, w_{q1}, . . . , w_{qn}, which share a zero point value z_{w} that is set to 0 and share the scaling value S. The quantized inner product operator 702 includes first multiplication operators 704 (8 bit integer operators in this example) and a summation operator 706 (a 16 bit or 32 bit integer operator in this example). Element-wise multiplication is performed by taking corresponding elements from the vectors X_{q} and W_{q} as inputs to the first multiplication operator 704. The number of first multiplication operators 704 required is equal to the length, n, of the vectors X_{q} and W_{q}. The outputs of the first multiplication operators 704 are all provided as input to the summation operator 706. The output of the summation operator 706 is rounded, using a rounding operator 708, to an 8 bit integer value for the integer output element Y_{q0} belonging to the quantized output vector Yₐ. The scaling values Sₓ and S_{w} are inputted to a second multiplication operator 710 (a floating point operator matching the format of the scaling values Sₓ and S_{W}) to output the scaling value S_{y} that is used to scale the quantized output vector Yₐ. It should be understood that each of the operators 704, 706, 708, 710 is implemented in hardware as circuitry that includes a set of logic gates that are in turn implemented using transistors.

Although quantization helps to reduce computational cost and/or memory usage for executing a neural network, the previously-discussed drawbacks of using multiplication operators for computing the inner product operator remain. The present disclosure describes example quantization schemes that may be used to quantize the squared Euclidean operator. Such quantization schemes may further improve reduce the computational cost and/or memory usage for computing the output of a neural network using the squared Euclidean operator.

The example quantization schemes are described based on 8 bit integer format, however this is not intended to be limiting (e.g., unsigned 8 bit integer format may be used instead, or any other integer formats may be used).

A first example quantization scheme disclosed herein, is as follows:

Xᵢ=S_{wx}(X_{qi}−z_{wx})

Wᵢ=S_{wx}(W_{qi}−z_{wx})

where X_{qi} is the quantized integer value of the input value Xᵢ, W_{qi} is the quantized integer value of the weight value Wᵢ, S_{wx} is the shared scaling value shared by all input values Xᵢ and all weight values Wᵢ, and z_{wx} is the shared zero point value shared by all input values Xᵢ and all weight values Wᵢ. To reduce the computational cost, the zero point value z_{wx} may be set to 0.

This first quantization scheme enables separation of the floating point and integer operations of the quantized squared Euclidean operator. Sharing of the scaling value S_{wx} and the zero point value z_{wx} by weights and input values helps to improve computation efficiency, but possibly at the expense of a drop in accuracy (which may be acceptable in some applications).

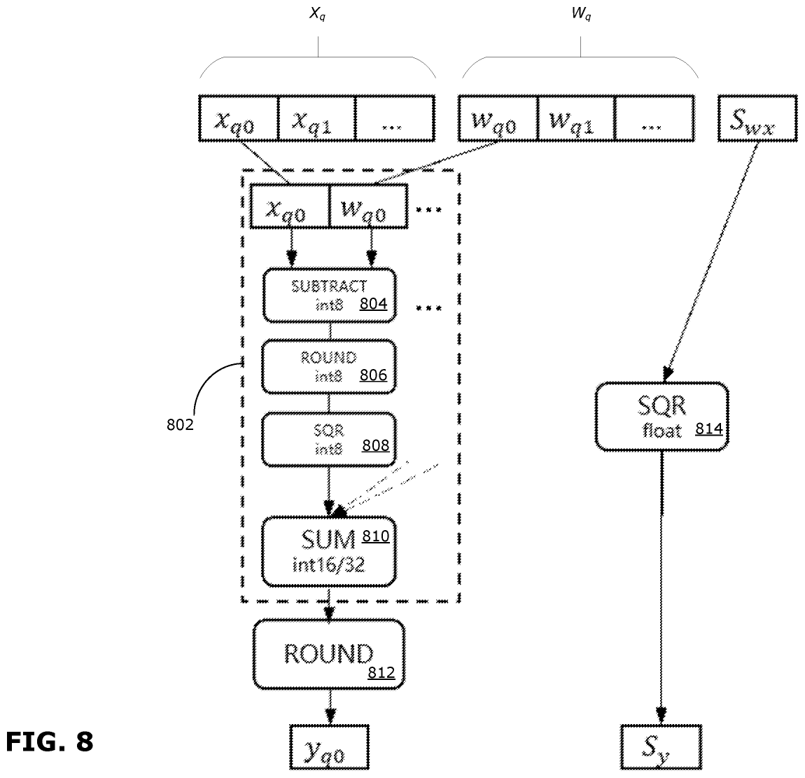

FIG. 8 is a computation graph illustrating the computations required to compute a quantized squared Euclidean operator using the first quantization scheme described above. The quantized input vector X_{q} contains the integer elements x_{q0}, x_{q1}, . . . , x_{qn}. The quantized weight vector W_{q} contains the elements w_{q0}, w_{q1}, . . . , w_{qn}. The zero point value z_{wx} is set to 0, and the scaling value S_{wx} is shared by the vectors X_{q} and W_{q}. The quantized squared Euclidean operator 802 includes subtraction operators 804 (8 bit integer operators in this example), first rounding operators 806 (8 bit integer operators in this example), first square operators 808 (8 bit integer operators in this example), and a summation operator 810 (a 16 bit or 32 bit integer operator in this example). Element-wise subtraction is performed by taking corresponding elements from the vectors X_{q} and W_{q} as inputs to a respective subtraction operator 804. The output of each subtraction operator 804 is provided as input to a respective first rounding operator 806, the output of which is provided as input to a respective first square operator 808. The outputs of the first square operators 808 are provided as input to the summation operator 810. The output of the summation operator 810 is rounded, using a second rounding operator 812, to an 8 bit integer value for the output element y₀, belonging to the quantized output vector Yₐ. The shared scaling values S_{wx} is inputted to a second square operator 814 (a floating point operator matching the format of the shared scaling value S_{wx}) to output the scaling value S_{y} that is used to scale the quantized output vector Yₐ. It should be understood that each of the operators 804, 806, 808, 810, 812, 814 is implemented in hardware as circuitry that includes a set of logic gates that are in turn implemented using transistors.

As would be appreciated by one skilled in the art, the subtraction operator 804, rounding operator 806 and square operator 808 together can be implemented using fewer logic gates (and hence fewer transistors) than the multiplication operator 704 of FIG. 7. Similarly, the square operator 814 can be implemented using fewer logic gates than the multiplication operator 710 of FIG. 7.

A second example quantization scheme disclosed herein, is as follows:

Xᵢ=S_{wx}(X_{qi}−zₓ)

Wᵢ=S_{wx}(W_{qi}−z_{w})

z_{x-w}=zₓ−z_{w}

where X_{qi} is the quantized integer value of the input value Xᵢ, W_{qi} is the quantized integer value of the weight value Wᵢ, S_{wx} is the shared scaling value shared by all input values Xᵢ and all weight values Wᵢ, zₓ is the zero point value shared by all input values Xᵢ, and z_{w} is the zero point value shared by all weight values Wᵢ. It should be noted that zₓ and z_{w} may be independently adjusted and may or may not be equal in value. During inference, the two zero point values may be combined into one zero value difference z_{x-w}, for computational efficiency.

Compared with the previous first quantization scheme (in which a single shared zero point value z_{w}, is shared by weights and input values), using separate zero point values zₓ and z_{w} in this second quantization scheme may help to reduce to quantization precision loss and help to improve accuracy, at the expense of an increase in computations (which may be acceptable in some applications, and which is generally still more efficient than computing the quantized inner product operator).

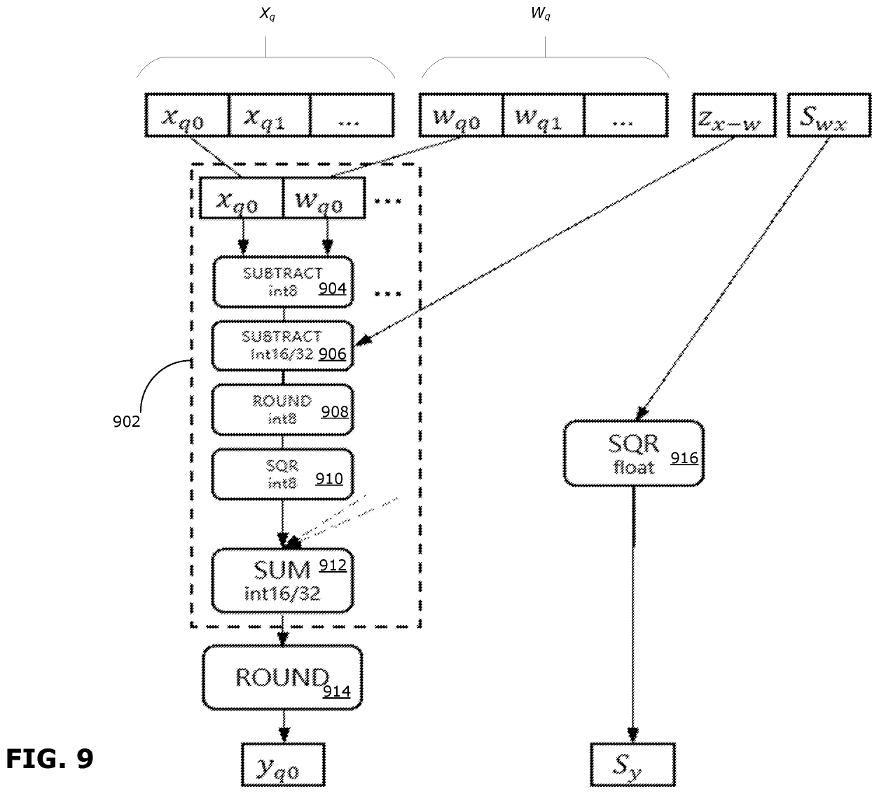

FIG. 9 is a computation graph illustrating the computations required to compute a quantized squared Euclidean operator using the second quantization scheme described above. The quantized input vector X_{q} contains the integer elements x_{q0}, x_{q1}, . . . , x_{qn}. The quantized weight vector W_{q} contains the elements w_{q0}, w_{q1}, . . . , w_{qn}. The zero value difference z_{x-w} is the difference between the zero point values zₓ and z_{w}, and the scaling value S_{wx} is shared by the vectors X_{q} and W_{q}.

The quantized squared Euclidean operator 902 includes first subtraction operators 904 (8 bit integer operators in this example), second subtraction operators 906 (16 bit or 32 bit integer operators in this example), first rounding operators 908 (8 bit integer operators in this example), first square operators 910 (8 bit integer operators in this example), and a summation operator 912 (a 16 bit or 32 bit integer operator in this example). Element-wise subtraction is performed by taking corresponding elements from the vectors X_{q} and W_{q} as inputs to a respective first subtraction operator 904. The output of each first subtraction operator 904 and the zero value difference z_{x-w} are provided as inputs to a respective second subtraction operator 906. The output of each second subtraction operator 906 is provided to a respective first rounding operator 908, the output of which is provided as input to a respective first square operator 910. The outputs of the first square operators 910 are provided as input to the summation operator 912. The output of the summation operator 912 is rounded, using a second rounding operator 914, to an 8 bit integer value for the output element y_{q0}, belonging to the quantized output vector Yₐ. The shared scaling values S_{wx} is inputted to a second square operator 916 (a floating point operator matching the format of the shared scaling value S_{wx}) to output the scaling value S_{y} that is used to scale the quantized output vector Y_{q}. It should be understood that each of the operators 904, 906, 908, 910, 912, 914, 916 is implemented in hardware as circuitry that includes a set of logic gates that are in turn implemented using transistors.

As would be appreciated by one skilled in the art, the operators 904, 906, 908, 910 together can be implemented using fewer logic gates (and hence fewer transistors) than the multiplication operator 704 of FIG. 7. Similarly, the square operator 916 can be implemented use fewer logic gates than the multiplication operator 710 of FIG. 7.

As previously mentioned, the squared Euclidean operator may be used to replace the inner product operator in any neural network layer in which the inner product operator is typically used.

For example, a conventional fully connected neural network layer typically is computed using the inner product operator. A fully connected neural network layer (also referred to simply as a fully connected layer) is a neural network layer in which every neuron (or computational unit) in the neural network layer is connected to each and every neuron in an adjacent neural network layer. A neural network that includes a fully connected neural network layer may also include one or more other neural network layers (e.g., convolutional neural network layers) that are not fully connected.

A fully connected neural network layer computed using the disclosed squared Euclidean operator may be referred to as a squared Euclidean-based neural network layer, or more specifically as squared Euclidean-based fully connected neural network layer. A squared Euclidean-based fully connected neural network layer may replace a conventional inner product-based fully connected neural network layer (i.e., a fully connected neural network layer that is computed using the inner product operator). As previously discussed, using the squared Euclidean operator instead of the inner product operator to compute the output of a neural network layer results in improved computational efficiency (e.g., requiring lower energy usage, fewer memory resources, fewer logic gates and/or lower processing power). Such improved efficiency may be particularly useful in the case of a fully connected neural network layer, due to the high number of computations typically required for computing the output of a fully connected neural network layer.

Computation of the output of the squared Euclidean-based fully connected neural network layer may be expressed as follows:

$${Y}_{i} = - \frac{1}{2} {\sum }_{j = 0}^{n} {( {X}_{j} - {W}_{i , j} )}^{2}$$

where Xⱼ is the j-th element of the input vector X, W₀ is the i,j-th element of the multi-dimensional weight vector W, Yᵢ is the i-th element of the output vector Y; and where

$$- \frac{1}{2}$$

is a constant scaling factor. The scaling factor is optional, and may be included to facilitate homotopy training, as described above.

The computing system 300 of FIG. 3, which has a neural network processor 320 that is designed to compute the squared Euclidean operator, may be used to compute the output of a neural network having one or more squared Euclidean-based fully connected neural network layers. A neural network that includes one or more squared Euclidean-based fully connected neural network layers may be trained using homotopy training, for example using the method 600 described above. The example quantization schemes described above may also be used to quantize the squared Euclidean-based fully connected neural network layer.

In another example, a conventional convolutional neural network layer is typically computed using the inner product operator. The inner product operator in the conventional convolution layer may be replaced with the squared Euclidean operator to obtain a squared Euclidean-based neural network layer, or more specifically a squared Euclidean-based convolutional neural network layer. Computation of the output of the squared Euclidean-based convolutional neural network layer may be expressed as follows:

$${Y}_{h , w , {c}_{out}} = - \frac{1}{2} {\sum }_{{c}_{i n} = 0}^{{N}_{i n}} {\sum }_{i = 0}^{k} {\sum }_{j = 0}^{k} {( {X}_{h + i , w + j , {c}_{i n}} + {W}_{i , j , {c}_{i n} , {c}_{out}} )}^{2}$$

where X_{h+i,w+j,c}_{ᵢₙ} is the (h+i),(w+j)-th element of the cᵢₙ-th dimension of the input data X, W_{h+i,w+j,c}_{ₒᵤₜ} is the i,j-th element of cᵢₙ,cₒᵤₜ-th dimension of the multi-dimensional weight vector W, is the Y_{h,w,c}_{ₒᵤₜ} is the h,w-th element of the cₒᵤₜ-th dimension of the output Y; and where

$$- \frac{1}{2}$$

is a constant scaling factor. The scaling factor is optional, and may be included to facilitate homotopy training, as described above.

The computing system 300 of FIG. 3, which has a neural network processor 320 that is designed to compute the squared Euclidean operator, may be used to compute the output of a neural network having one or more squared Euclidean-based convolutional neural network layers. A neural network that includes one or more squared Euclidean-based convolutional neural network layers may be trained using homotopy training, for example using the method 600 described above. The example quantization schemes described above may also be used to quantize the squared Euclidean-based convolutional neural network layer.

The squared Euclidean-based convolutional neural network layer may also be decomposed into conventional convolutional neural network layers (which are computed using the inner product operator), to enable computation using a conventional processing unit that is optimized for computing the inner product operator. For example, a compiler or other software may convert instructions for computing a squared Euclidean-based convolutional neural network layer using the squared Euclidean operator into instructions to compute the squared Euclidean-based convolutional neural network layer using a sum of inner products. The decomposition of the squared Euclidean-based convolutional neural network layer may be expressed as follows:

$$EuclidConv ( X , W ) = Conv ( X , W ) - \frac{1}{2} Conv ( {X}^{2} , 1 ) - \frac{1}{2} SUM ( {W}^{2} )$$

where EuclidConv is the squared Euclidean-based convolutional neural network layer, Cony is the conventional inner product-based convolutional neural network layer, X is the input vector, and W is the weight vector. It should be noted that the vectors X and W may represent multi-dimensional data (e.g., may represent 2D matrices)

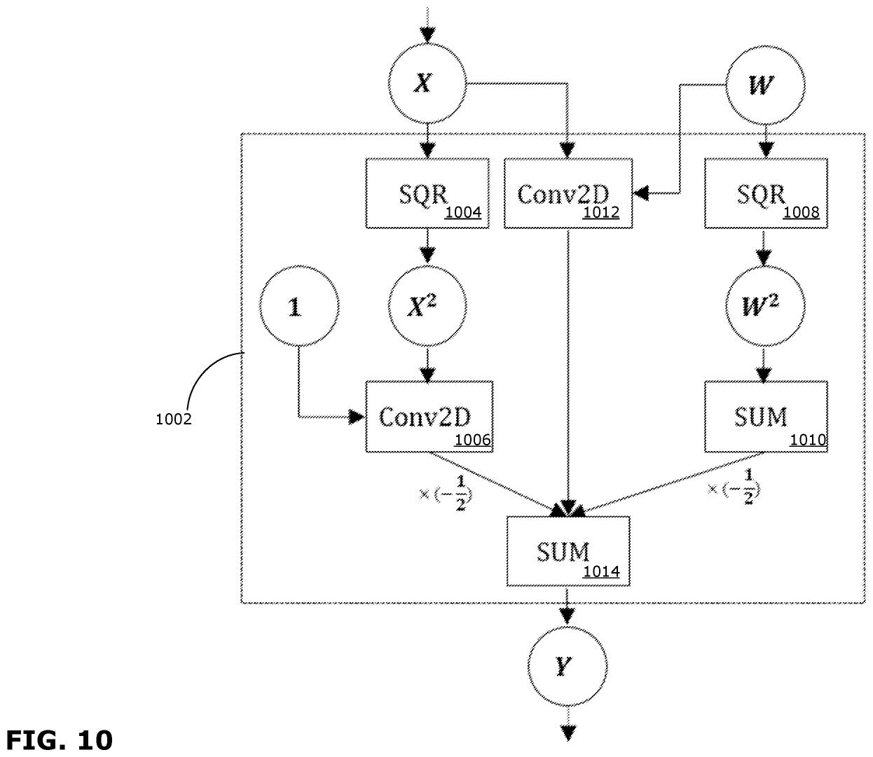

FIG. 10 is a block diagram illustrating an example of how a squared Euclidean-based convolutional neural network layer may be computed as a sum of conventional inner product-based convolutional neural network layers. This example illustrates computation of a 2D squared Euclidean-based convolutional neural network layer, however it should be understood that similar computations may be used for any other dimensionality.

Computation of the output of the squared Euclidean-based convolutional neural network layer in this example is decomposed into a set of computations 1002 that include a sum of conventional inner product-based convolutions. The input vector X is inputted to a first square operator 1004, to obtain the squared vector X². The squared vector X² and all-1 matrix are inputted to a first 2D convolution operator 1006, which performs conventional 2D convolution using the inner product operator. The output of the 2D convolution operator 1006 is multiplied by the constant −½, and inputted to a final summation operator 1014. The weight vector W is inputted to a second square operator 1008, to obtain the squared vector W². The squared vector W² is inputted to a summation operator 1010. The output of the summation operator 1010 is multiplied by the constant −½, and inputted to the final sum operator 1014. The input vector X and weight vector W are also inputted to a second 2D convolution operator 1012, which performs conventional 2D convolution using the inner product operator. The output of the 2D convolution operator 1006 is inputted to the final summation operator 1014. The output of the final summation operator 1014 is the output vector Y (which may represent multi-dimensional data, such as a 2D matrix).

To enable training of a neural network that includes one or more squared Euclidean-based convolutional neural network layers using homotopy training (e.g., using the method 600 described above), a residual operator may be defined as follows:

$${ResidualOperator}_{InnerConv \to EuclidConv} ( X , W , λ ) = - \frac{λ}{2} ( Conv ( {X}^{2} , 1 ) + SUM ( {W}^{2} ) )$$

The HT operator may then be defined as follows:

HTOperator(X,W,λ)=SourceOperator_{InnerConv}(X,W)+λ×ResidualOperator_{InnerConv→EuclidConv}(X,W,λ)

As previously described, the HT parameter λ is gradually increased from a value of 0 to a value of 1, the HT operator is gradually converted from the source operator (i.e., the inner product-based convolution) to the target operator (i.e., the squared Euclidean-based convolution). The homotopy training, for converting a conventional inner product-based convolutional neural network layer to a squared Euclidean-based convolutional neural network layer, may be performed similar to method 600 described above, using the HT operator defined above.

The quantization schemes disclosed herein may be used to quantize the squared Euclidean-based convolutional neural network layer. However, the scaling value and zero point value may be shared only along h,w and cᵢₙ dimensions. For the output Y(h, w, cₒᵤₜ), each cₒᵤₜ dimension may have its own scaling factor and zero point. This may help to alleviate any accuracy drop caused by quantization.

An example quantization scheme for a squared Euclidean-based convolutional neural network layer is defined as follows:

X_{h,w,c}_{ᵢₙ}=S_{wx}(X_{q(h,w,c}_{ᵢₙ}₎−z_{wx})

W_{i,j,c}_{ᵢₙ}_{,c}_{ₒᵤₜ}=S_{wx}(W_{q(i,j,c}_{ᵢₙ}_{,c}_{ₒᵤₜ}₎−z_{wx})

where X_{q(h,w,c}_{ᵢₙ}₎ is the quantized integer representation of the input X_{h,w,c}_{ᵢₙ}, W_{q(i,j,c}_{ᵢₙ}_{,c}_{ₒᵤₜ}₎ is the quantized integer representation of the weight W_{i,j,c}_{ᵢₙ}_{,c}_{ₒᵤₜ}, S_{wx} is the shared scaling value shared by all inputs and weights, and z_{wx} is the shared zero point value shared by all inputs and weights. It can be seen that this example quantization scheme for the squared Euclidean-based convolutional neural network layer is similar to the first quantization scheme previously described (in which the scaling value and the zero point value are shared by both inputs and weights). It should also be understood that another example quantization scheme for the squared Euclidean-based convolutional neural network layer may be similar to the second quantization scheme previously described (in which the scaling value is shared by both inputs and weights, but there are separate zero point values for the inputs and for the weights).

The computations for computing the output of the quantized squared Euclidean-based convolutional neural network layer may be similar to those described above with reference to FIGS. 8 and 9, depending on the quantization scheme used.

In various examples, the present disclosure has described methods, devices and systems for computing the output of a neural network, in which a disclosed squared Euclidean operator is used in place of the inner product operator. A neural network that is based on the squared Euclidean operator uses squared Euclidean distance as a similarity measure, instead of the conventional inner product similarity. The disclosed methods, devices and systems may be used to compute the output of any neural network (e.g., having any network architecture, and designed for any inference task).

The squared Euclidean operator may be used to replace the inner product operator in any neural network layer that conventionally uses the inner product operator. For example, a convolutional neural network layer may be computed using the squared Euclidean operator instead. In another example, a fully connected neural network layer may be computed using the squared Euclidean operator instead.

The present disclosure also describes an example method that enables a conventional processing unit, designed for computing inner product operators, to compute a squared Euclidean-based neural network, using a decomposition of the squared Euclidean operator into a sum of inner product operators.

The present disclosure also describes an example method for training a squared Euclidean-based neural network, using a trained conventional inner product-based neural network as a starting point. The example method is referred to as homotopy training, in which the trained conventional inner product-based neural network is gradually converted to a squared Euclidean-based neural network, using a homotopy training operator as disclosed herein.

The present disclosure also describes example quantization scheme that may be used to quantize computation of the squared Euclidean operator. The example quantization schemes may be used to quantize any squared Euclidean-based neural network layer, such as a squared Euclidean-based convolutional neural network layer. Other neural network layers that conventionally use the inner product operator, such as an attention neural network layer, may be similarly replaced by a squared Euclidean-based neural network layer.

It has been found, in various studies and simulations, that a squared Euclidean-based neural network that is trained using the homotopy training disclosed herein, may achieve the same prediction accuracy on a large image dataset as a conventional inner product-based convolutional neural network.

The disclosed examples thus enable a neural network to be computed in a more efficient manner, for example by requiring lower power usage, fewer memory resources, lower computing power and/or smaller hardware footprint, compared to conventional computation of neural networks. This may help to enable computation (e.g., during inference) of a neural network in a computing system having more limited resources (e.g., in an edge computing system).

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computing system for computing an output of a neural network layer of a neural network, the computing system comprising:
a memory storing a weight vector for the neural network layer; and
a processing unit coupled to the memory, the processing unit comprising:
circuitry configured to receive an input vector to the neural network layer and the weight vector for the neural network layer;
circuitry configured to compute a squared Euclidean distance between the input vector and the weight vector by:
for each element in the input vector and a corresponding element in the weight vector, computing a first difference and computing a square of the first difference; and
computing a sum of the squares to obtain the squared Euclidean distance; and
circuitry configured to output the squared Euclidean distance as an output element of an output vector of the neural network layer.

2. The computing system of claim 1, wherein, in the processing unit, the circuitry configured to compute the squared Euclidean distance comprises:
logic gates for implementing a subtraction operator to compute the first difference;
logic gates for implementing a square operator to compute the square of the first difference; and
logic gates for implementing a summation operator to compute the sum of the squares.

3. The computing system of claim 1, wherein the neural network layer is a convolutional neural network layer, wherein the weight vector is a convolutional kernel, and wherein the memory stores instructions to cause the processing unit to compute the output vector of the convolutional neural network layer using the squared Euclidean distance between the input vector and the convolutional kernel.

4. The computing system of claim 1, wherein the neural network layer is a fully connected neural network layer, wherein the weight vector represents multi-dimensional weights and wherein the memory stores instructions to cause the processing unit to compute the output vector of the fully connected neural network layer using the squared Euclidean distance between each element in the input vector and each multi-dimensional weight represented by the corresponding element in the weight vector.

5. The computing system of claim 1, wherein the processing unit is a dedicated neural network accelerator chip.

6. The computing system of claim 1, wherein the input vector and the weight vector are integer vectors, and wherein:
the circuitry configured to receive the input vector and the weight vector is further configured to receive a scaling value; and
the circuitry configured to compute the squared Euclidean distance is further configured to compute the squared Euclidean distance by:
for each element in the input vector and a corresponding element in the weight vector, computing the first difference, rounding the first difference, and computing a square of the rounded difference; and
computing the sum of the squares and rounding the sum to obtain the squared Euclidean distance;
the processing unit further comprising:
circuitry configured to compute a square of the scaling value;
wherein the circuitry configured to output the squared Euclidean distance is further configured to output the square of the scaling value as an output scaling value of the output vector.

7. The computing system of claim 6, wherein:
the circuitry configured to receive the input vector, the weight vector and the scaling value is further configured to receive a zero value difference; and
the circuitry configured to compute the squared Euclidean distance is further configured to compute the squared Euclidean distance by:
for each element in the input vector and a corresponding element in the weight vector, computing the first difference, computing a second difference between the first difference and the zero value difference, rounding the second difference, and computing the square of the rounded difference; and
computing the sum of the squares and rounding the sum to obtain the squared Euclidean distance.

8. A method comprising:
obtaining a set of pre-trained weights of a first neural network, the first neural network including a first neural network layer computed using an inner product operator, the inner product operator being defined based on inner product similarity;
initializing a set of weights of a second neural network using values from the set of pre-trained weights, the second neural network having a network architecture equivalent to the first neural network, the second neural network replacing the first neural network layer with a second neural network layer computed using a homotopy training operator, the homotopy training operator being a continuous function that transforms the inner product operator to a squared Euclidean operator, the squared Euclidean operator being defined based on squared Euclidean similarity;
initializing the homotopy training operator to be equivalent to the inner product operator;
updating the set of values of weights of the second neural network over a plurality of training iterations, the homotopy training operator being adjusted towards the squared Euclidean operator over the plurality of training iterations; and
after the homotopy training operator has transformed to the squared Euclidean operator and a convergence condition is satisfied, storing the updated set of values of the weights as a set of trained values of the weights of the second neural network.

9. The method of claim 8, wherein the homotopy training operator is a parametric function, and wherein the homotopy training operator is adjusted towards the squared Euclidean operator by adjusting a continuous homotopy training parameter.

10. The method of claim 9, wherein initializing the homotopy training operator comprises initializing the homotopy training parameter to a value of zero, and wherein the homotopy training operator is adjusted towards the squared Euclidean operator by adjusting the homotopy training parameter towards a value of one.

11. The method of claim 9, wherein the homotopy training operator is defined as:
homotopy trainng operator=inner product operator+λ×residual operator
wherein λ is the homotopy training parameter, and the residual operator is defined as the difference between the squared Euclidean operator and the inner product operator.

12. A method for computing an output of a neural network layer of a neural network, the method comprising:
receiving an input vector to the neural network layer and a weight vector for the neural network layer;
computing a squared Euclidean distance between the input vector and the weight vector by:
computing a first inner product between the input vector and the weight vector;
computing a second inner product between the input vector and the input vector itself and applying a scaling factor;
computing a third inner product between the weight vector and the weight vector itself and applying the scaling factor; and
computing a sum of the first inner product, the scaled second inner product and the scaled third inner product to obtain the squared Euclidean distance; and
outputting the squared Euclidean distance as an output element of an output vector of the neural network layer.

13. The method of claim 12, wherein the neural network layer is a convolutional neural network layer, wherein the weight vector is a convolutional kernel, and wherein the method comprises:
computing the output vector of the convolutional neural network layer using the squared Euclidean distance between the input vector and the convolutional kernel, the squared Euclidean distance being computed by computing the first inner product, the second inner product, the third inner product and the sum.

14. The method of claim 12, wherein the neural network layer is a fully connected neural network layer, wherein the weight vector represents multi-dimensional weights and wherein the method comprises:
computing the output vector of the fully connected neural network layer using the squared Euclidean distance between each element in the input vector and each multi-dimensional weight represented by the corresponding element in the weight vector, the squared Euclidean distance being computed by computing the first inner product, the second inner product, the third inner product and the sum.

15. The method of claim 12, further comprising:
converting instructions to compute the squared Euclidean distance by computing a squared Euclidean operator into instructions to compute the squared Euclidean distance by computing the first inner product, the second inner product, the third inner product and the sum.
